(19) United States
(12) Patent Application Publication
(10) Pub. No.: US 2015/0115539 A1
(43) Pub. Date: Apr. 30, 2015

(54) SHAFT SEAL WITH LAMELLAE

(71) Applicant: EN3 GMBH, Rostock (DE)

(72) Inventors: Norbert Guenther, Ribnitz-Damgarten (DE); Guenther Eggert, Rostock (DE); Robert Engel, Laage (DE); Toralf Genz, Rostock (DE)

(21) Appl. No.: 14/398,602

(22) PCT Filed: Apr. 26, 2013
(86) PCT No.: PCT/EP2013/058710

§ 371 Date: Nov. 3, 2014

(30) Foreign Application Priority Data
May 3, 2012 (DE) 10 2012 009 095.1

(51) Int. Cl. F16J 15/32

(52) U.S. Cl. CPC F16J 15/3204
USPC 277/361

(57) ABSTRACT

The disclosure relates to an apparatus for sealing shafts, the apparatus comprising at least one device for positioning at least one first sealing means and a second sealing means on a shaft in a specified manner. At least the first sealing means has a partly elastic wall region for restricting a fluid passage out of a first region, in which a fluid is provided, into a second region, from which the shaft is sealed by the first region. The wall region forms an opening through which the shaft is guided, the diameter of the opening being variable dependent on the diameter of the shaft, and the second sealing means lies over the first sealing means so as to contact same at least in some regions in order to seal the fluid passage.

The present invention belongs to the domain of shaft seals and makes it possible, for example, to seal off a machine housing from the surrounding area where elements pass out or where there are round components, or makes it possible in general to seal off rotating shafts from pressurising media, in particular at high temperatures.

Various rotating shaft seals for sealing off rotating shafts from pressurised media are already known. Some of these have been introduced into practice as technical standards.

The technical challenge for effective seals always consists of appropriately combining an elastic sealing element, for example an O-ring or round ring, which lies tightly around the rotating shaft, with abrasion resistance, by means of which the rotating shaft is not damaged, and the sealing element having a degree of extra elasticity here so that operation can go on for a long time, even at high temperatures. In some applications there are also requirements for chemical resistance to aggressive media. These partially contradictory requirements are mostly fulfilled to a greater or lesser extent by known technical solutions.

The known technical solutions, which have arisen from the use of an O ring, have also been developed as shaping rings and are known under the trade name Simmerring. For certain applications the so-called sliding ring seal is known which is suitable for high temperature ranges and is also used with aggressive media. This sealing system can not dispense with elastic components which balance out play or wobbling of the rotating shaft with respect to the fixed housing environment either. Elastic elements such as O rings or bellows are also partially used here.

In comparison to simple O ring seals, sliding ring seals are designed to be longer in the axial direction, and this then prevents them from being used for reasons relating to space.

It is therefore the object of the present invention to devise solutions for seals for rotating shafts which are suitable for use in high temperature ranges, that in particular have short overall lengths in the shaft direction and that can be exchanged with standard shaft seals.

This object is achieved by an apparatus for sealing off shafts or machine housings or a shaft seal according to claim 1. The latter has a device for the pre-determined, in particular coaxial positioning of at least a first and a second sealing means on a shaft, at least the first sealing means having an at least partially elastic wall region for limiting the passage of material from a first region, in which a fluid is preferably provided, into a second region with respect to which the shaft is sealed off from the first region, the elastic wall region forming an opening through which the shaft is passed, the diameter of which can be changed dependently upon the diameter of the shaft, and the second sealing means overlapping the first sealing means at least partially, and preferably with contact, so as to further reduce and preferably so as to seal off or totally reduce the passage of material.

It is particularly preferred here if, by means of the device for pre-determined positioning, an arrangement of sealing means lying one on top of the other, which can also be called a packet, can be positioned securely and tightly in the unit housing surrounding the shaft bearing. The device or the holder for positioning the packets can have dimensions here which correspond to the standard dimensions for shaft seals.

According to one preferred embodiment the partially elastic wall region of the first sealing means is formed by lamellae extending at least in the direction of the opening and which are at least partially elastically deformable in order to be brought into contact with the shaft, slots formed between the lamellae being at least partially overlapped, in particular with contact, by the second sealing means so as to further reduce the passage of material or so as to seal off the passage of material.

This configuration is advantageous because, due to their elastic properties, the lamellae even out vibrations of the shaft and in this way are always in contact with the shaft in every operational state, by means of which an advantageous sealing effect can be achieved.

According to another preferred embodiment of the present invention the second sealing means also has lamellae which define an opening through which the shaft is passed, the openings in the sealing means particularly preferably being arranged coaxially.

This is advantageous because, due to their elasticity, both sealing means contribute to pressing the lamellae in contact with the shaft against the shaft.

According to another preferred embodiment of the present invention the first sealing means and the second sealing means are arranged one over the other in the axial direction, i.e. preferably in the direction of the longitudinal axis of the shaft or of the shaft to be sealed off such that every slot between the lamellae is covered by a lamella of the other sealing means, and as a consequence of an increase in pressure resulting from the material a contact pressure exerted upon the first sealing means by the lamellae of the second sealing means also increases. In other words, packets of preferably press-formed, slotted, circular ring-shaped discs are laid one over the other such that every disc is offset by a defined, in particular half angular distance with the slots opposite discs arranged on top or underneath.

This embodiment is advantageous because automatic adjustment of the packets by the medium pressure is possible or takes place during operation by polished, inner running edges of the discs being replaced by discs lying over them so as to guarantee long operating times. Moreover, this embodiment is advantageous because, dependently upon a change in pressure of the material, the contact pressure of the contact pressure exerted by the second upon the first sealing means can change, and so a sufficient sealing effect is always guaranteed.

According to another preferred embodiment of the present invention at least one slot in the region of the transition of two lamellae into a base body of the sealing means is made so as to be at least partially spherical, in particular round in form by the base body section of the sealing means that connects two lamellae respectively.

Moreover, it is conceivable here for the diameter of the round slot portion to be a multiple of the slot width of the longitudinally extending slot portion, at least in a non-fitted state. In other words, this means that the first sealing means or the first and the second sealing means are preferably slotted from an inner ring edge radially outwards with equal angular distances, the slot ends being rounded. The number of slots can vary here between the sealing means, and they preferably have identical numbers of slots and identical lamellae. Preferably, the number of lots exceeds 5 or 10 or 15 slots or generally constitutes a larger number of slots.

According to another preferred embodiment of the present invention at least one sealing means is produced from a metal sheet or a film, the shaft seal preferably being made of press-formed sheet metal or film packets which adapt to a rotating shaft.

This is advantageous because circular ring-shaped, thin discs made of metal or other temperature-resistant materials can be used to produce the sealing means. Particularly preferably, the first and second or all of the sealing means are identical in form, the second (or the respective next) sealing means also being able to be made larger than the first sealing means or being able to have longer lamellae, a larger opening and/or a larger base body in comparison to the first sealing means.

The sealing means or the shaft seal is preferably arranged such that the incline of the lamellae is in the direction opposing the direction of the active pressure of the medium to be sealed, corresponding to the concave side of the packet of discs.

According to another preferred embodiment of the present invention at least three sealing means, in particular a first sealing means, a second sealing means and at least or precisely a third sealing means are provided. Preferably however, at least or precisely 2, 3, 4, 5, 6, 7, 8, 9, 10 or more sealing means are provided. Particularly preferably at least or precisely 1, 2, 3, 4, 5, 6, 7, 8, 9, 10 sealing means are provided that have lamellae.

The arrangements of layered sealing means or of packets of discs preferably have a high degree of elasticity due to the fact that the individual discs are thin and the number of discs in one packet is high. Therefore, the thickness of a packet comprising sealing means arranged one over the other in layers is of a length which is preferably a multiple of the width of the packet. Another advantageous property of the discs is high temperature stability by using materials or combinations of materials chosen from the group consisting at the very least of metal, carbon, ceramic, composite material/s, plastic/s etc.

Preferably, materials which have a good hardness step to the hardness of the shaft, i.e. which contribute to the prevention of grinding into the surface of the shaft, are preferably used as materials for the discs or sealing means. Furthermore, the sealing means have resistance to aggressive media, e.g. due to the material from which they are made. However, this resistance can alternatively or additionally be generated or improved by coating the discs once/a number of times and/or by special treatment methods.

According to another preferred embodiment of the present invention the device has at least one outer ring and one inner ring for the pre-determined positioning of the sealing means, the sealing means being disposed in between at least partially or in certain sections. Preferably, portions, in particular the portions of the base body facing away from the opening of one, several or all of the sealing means which have lamellae are disposed between the outer ring and the inner ring. Particularly preferably, a sealing means or the sealing means is/are connected or coupled non-rotatably to the outer ring and/or the inner ring such that displacement and/or rotation of the base body portions of one, several or all of the sealing means with respect to the outer and/or inner ring is only possible to a limited extent or is out of the question. This can be brought about releaseably or unreleaseably, for example by means of form-locked, adhesively bonded, frictionally engaged or field-locked connections or couplings. Furthermore, it is conceivable for two, several or all of the sealing means that have lamellae to be coupled or to be able to be coupled non-rotatably to one another, releaseably or non-releaseably.

Preferably, the packets of sealing means, which preferably all have lamellae, are fitted such that they are secured against rotation or entrainment against the frictional forces on the shaft circumference acting in the circumferential direction.

According to another preferred embodiment of the present invention the sealing means or the first sealing means and the second sealing means are in the form of press-formed, in particular slotted, circular ring-shaped discs or lamellar discs, in particular made of a respective standardised temperature-resistant material. The circular ring-shaped discs are preferably press-formed such that they take on the form of annular dishes. Furthermore, it is preferably possible to fit packets of press-formed, slotted, circular ring-shaped discs into fixed annular holders such that the inner edges are free to a shaft rotating obliquely in the axial direction and in relation to a rotating shaft to be sealed off in the discs.

This is advantageous because in this way deflections of the shaft can be absorbed elastically by the lamellae without any risk of damage to the shaft/seal or by the risk being clearly reduced.

According to another preferred embodiment of the present invention the device for the pre-determined positioning of the sealing means or for the predetermined positioning of the first sealing means and/or the second sealing means has an annular fitting with a groove at least partially adapted to the shape of the sealing means for receiving the sealing means or the first and/or second sealing means, at least with form-fit. The device is thus preferably formed by a fitting, the groove on one side preferably having, at least in some sections, means for holding the sealing means, in particular the first and/or second sealing means, on the device, in particular a partially or totally circumferential shoulder.

Within the context of the present invention sealing off preferably describes the reduction of a material exchange between two regions, and particularly preferably the substantial or actually total reduction/limitation of the material exchange. Pourable materials, in particular fluids, i.e. gases, liquids or combinations of the latter, can preferably be considered as materials here.

According to another preferred embodiment of the present invention the sealing means are in the form of press-formed sealing sleeves.

This is advantageous because in this way shafts with a very large diameter can also interact in a reliable and space-saving manner in order to seal off a first region from a second region with the seal according to the invention.

In all of the exemplary embodiments the thin initial metal sheets or films are preferably selected according to the thickness values of the material and the material values as regards temperature resistance, medium resistance and/or abrasion resistance.

The sealing performance of the system improves as the number of sealing lamellae or sealing sleeves that can be combined in one packet increases, i.e. with a given packet thickness, if the thinnest possible metal sheets or films are used which guarantee fulfilment of the function.

Furthermore, it is conceivable for the invention to relate to a previously described sealing means, in particular a sealing means with lamellae, or to its use in a shaft seal, in particular in a previously described shaft seal.

Additional advantages, aims and properties of the present invention are described by means of the following description of the attached figures in which shaft seals and/or their components are shown as examples. Components of the shaft seals, which at least substantially correspond as regards their function in the figures, can be identified here by the same reference numbers, these components not having to be numbered or described in all of the figures.

These show as follows:

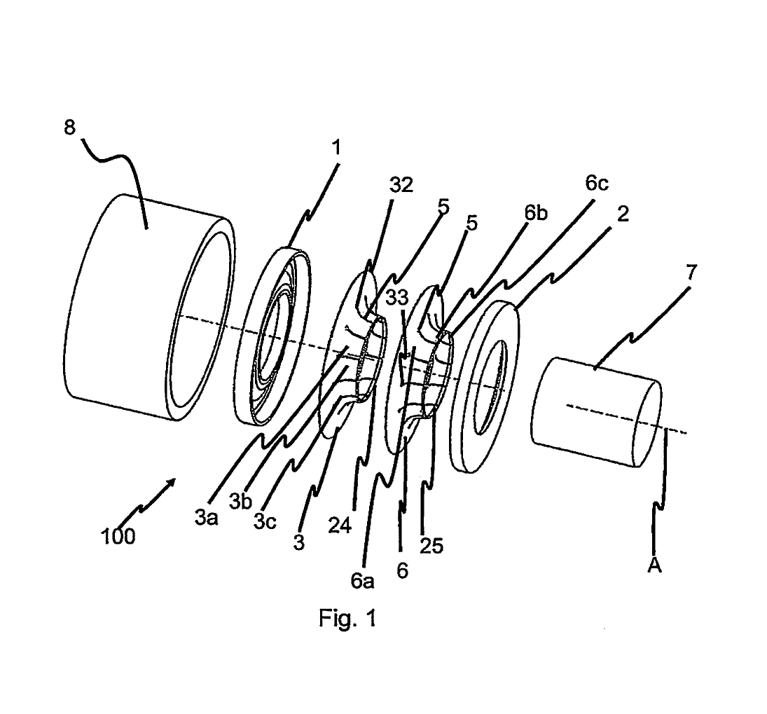

FIG. 1 an exploded illustration of a first shaft seal according to the invention;

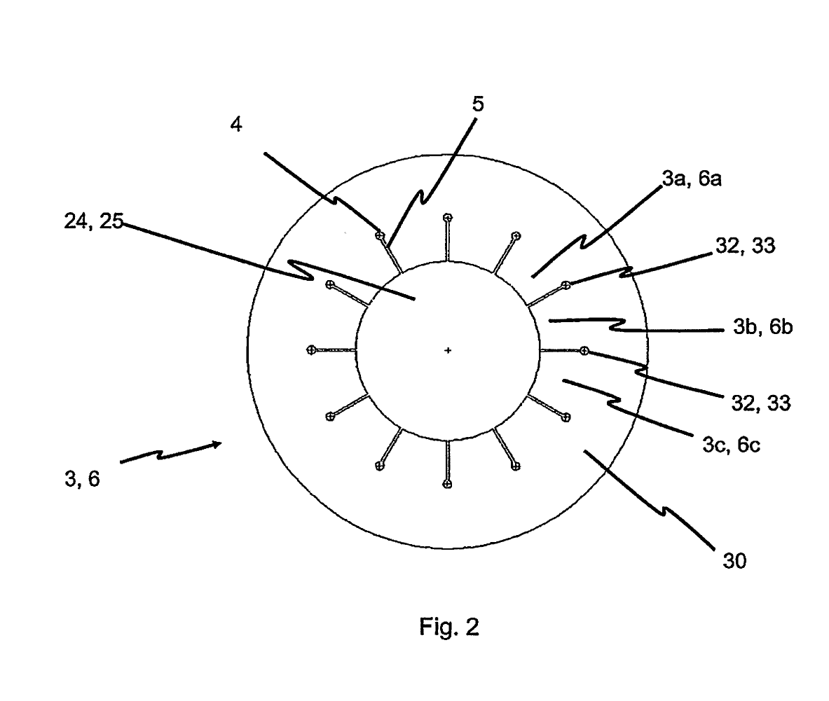

FIG. 2 a top view of a circular lamellar disc for use in the shaft seal shown in FIG. 1;

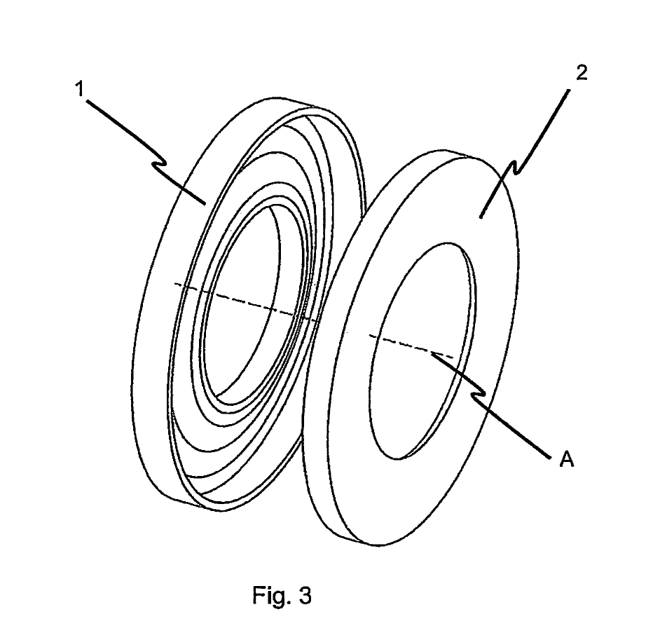

FIG. 3 a three-dimensional overall representation of an outer support ring and an inner support ring for use in the shaft seal shown in FIG. 1;

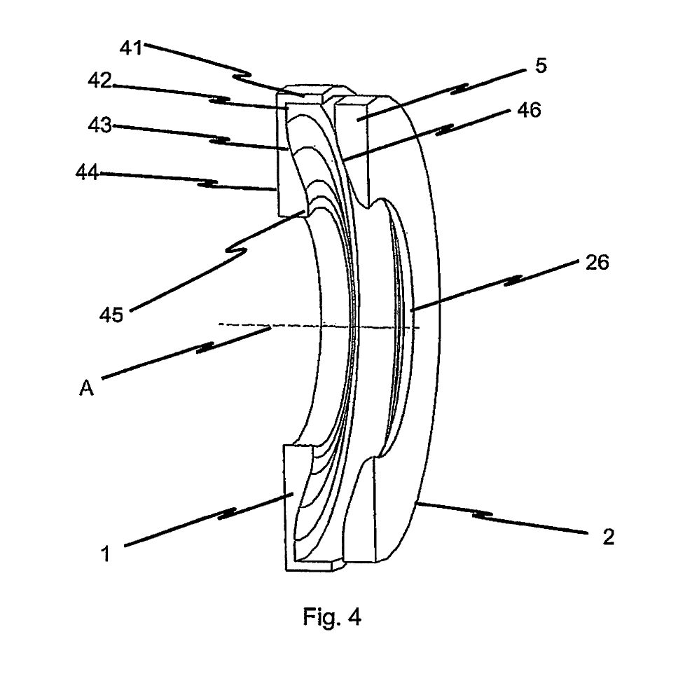

FIG. 4 a sectional view through the support rings shown in FIG. 3 in a centre plane;

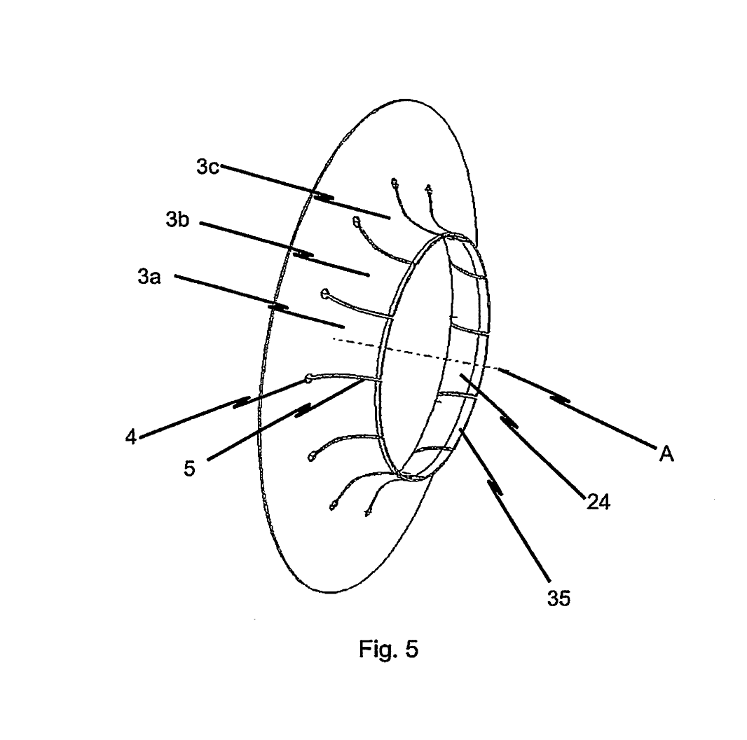

FIG. 5 a three-dimensional representation of a press-formed lamellar disc with inner slots and roundings at the slot ends;

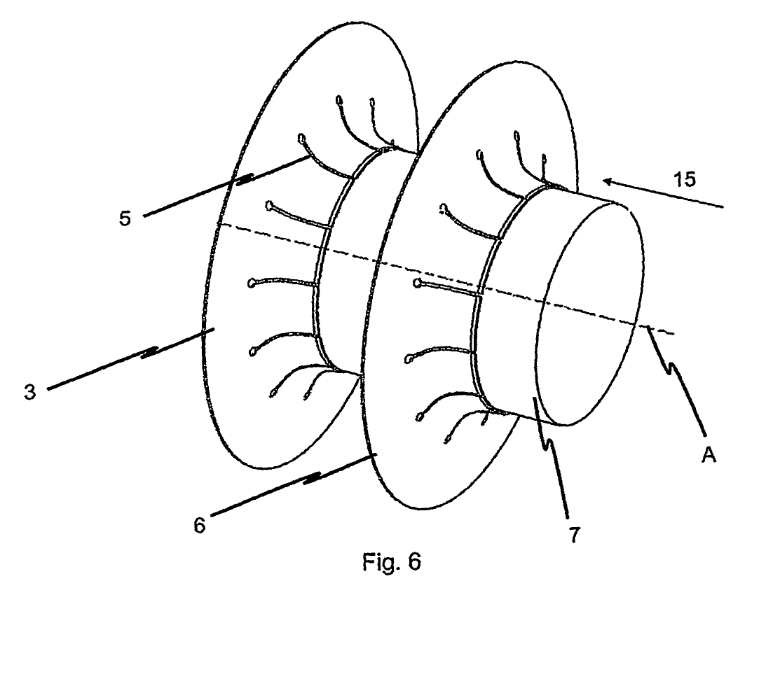

FIG. 6 lamellar discs on a shaft, arranged with an angular offset to one another;

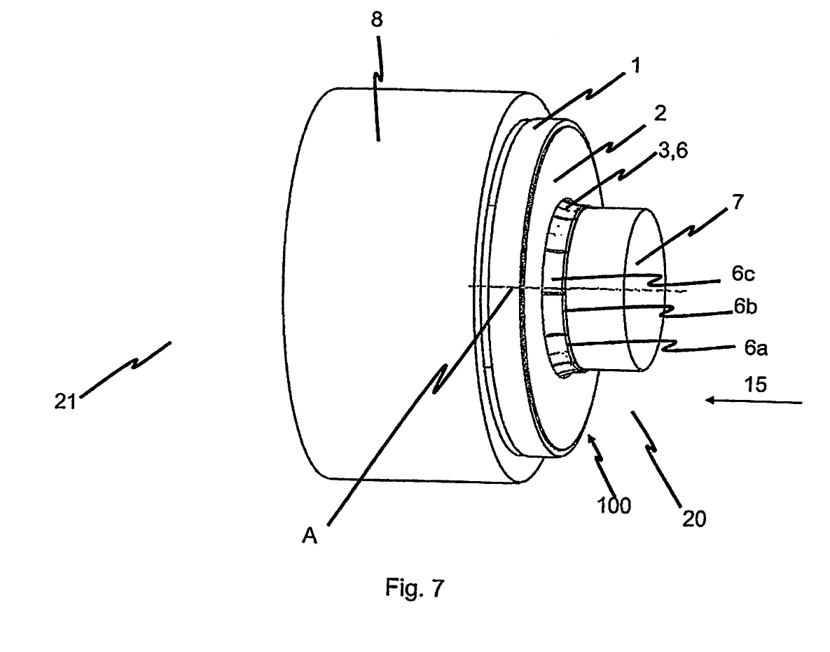

FIG. 7 an assembled shaft seal in the fitted state;

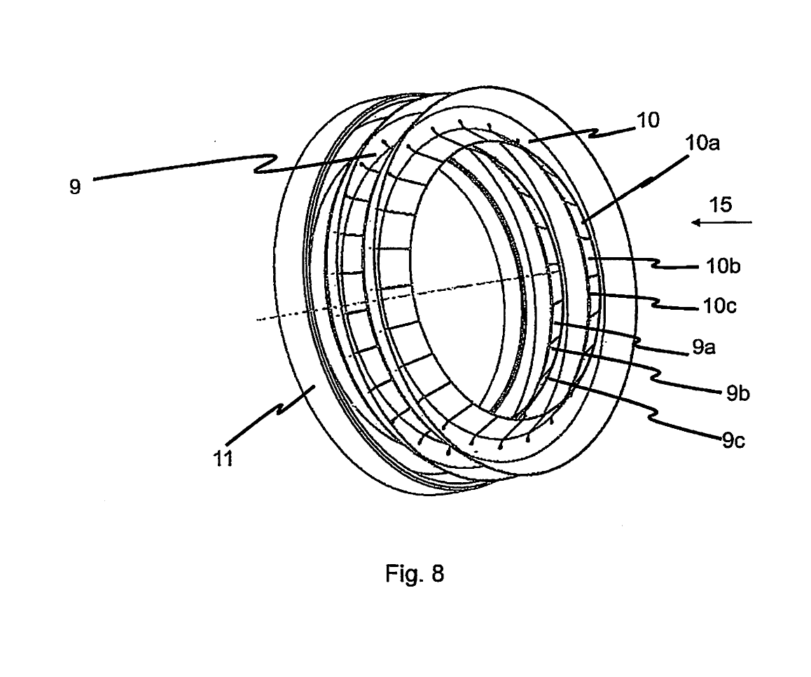

FIG. 8 an illustration of an additional shaft seal according to the invention;

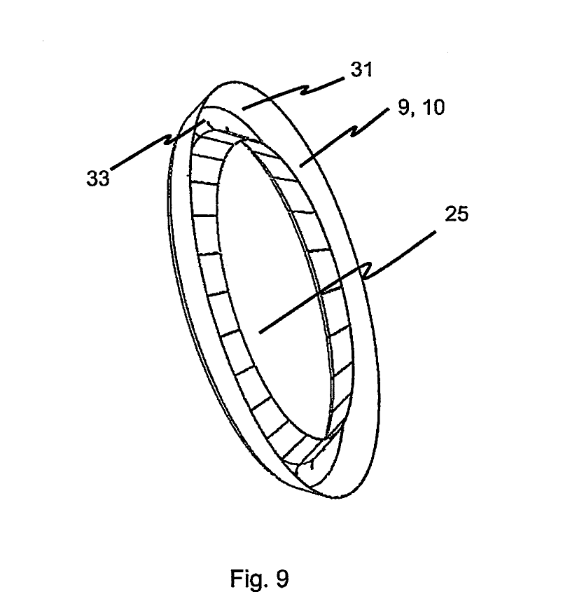

FIG. 9 a three-dimensional representation of a press-formed sealing sleeve for use in the shaft seal shown in FIG. 8;

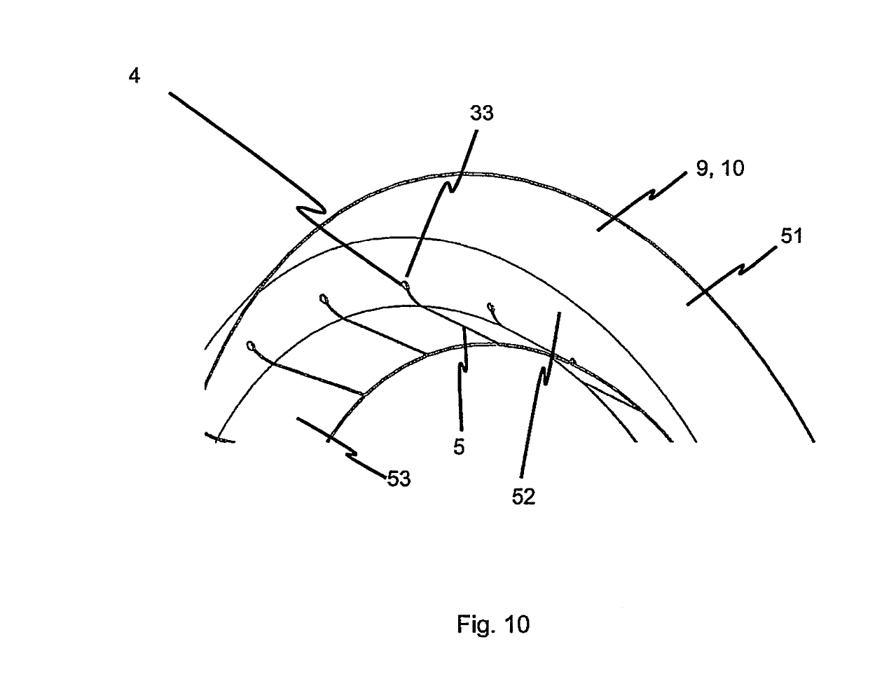

FIG. 10 a detailed illustration of a section of the sealing sleeve shown in FIG. 9;

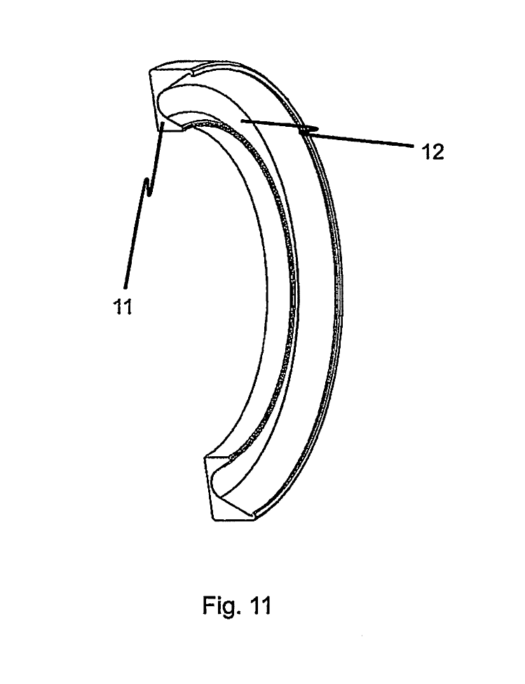

FIG. 11 a sectional illustration of a fitting for receiving the sealing sleeve shown in FIG. 9; and

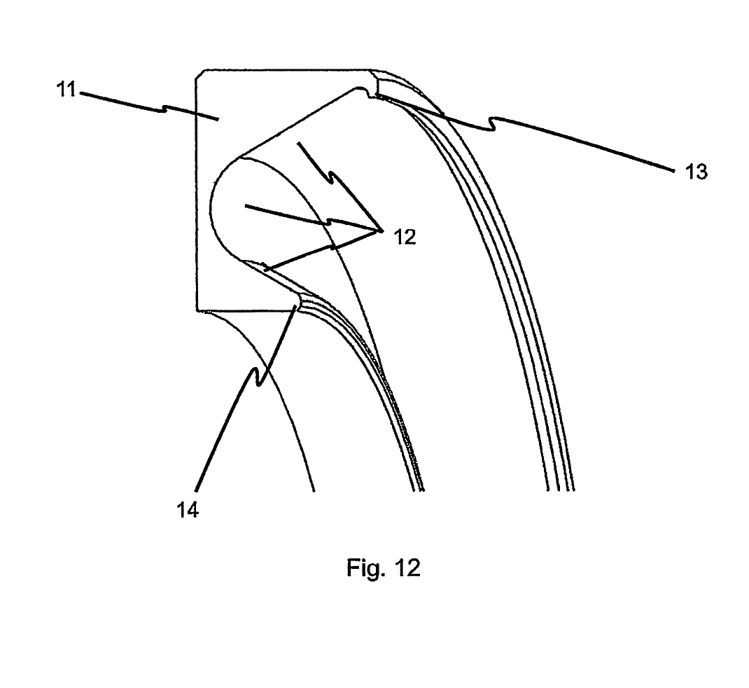

FIG. 12 a detailed illustration of a section of the fitting shown in FIG. 11.

In FIG. 1 a first embodiment of the shaft seal 100 according to the invention is shown, according to which the object underlying the invention is preferably achieved by the use of round, thin, circular, finger-shaped or bar-shaped lamellae 3a, 3b, 3c; 6a, 6b, 6c which form central openings 24 from the opening edge of which slots pass 5 directed radially outwards in a star shape. The lamellae 3a, 3b, 3c are formed here on the first sealing means 3 and the lamellae 6a, 6b, 6c are formed here on the second sealing means 6. By means of the rotatable shaft 7 passing through the openings 24, 25, the central openings 24, 25 can be widened and a number of the circular lamellae 3a, 3b, 3c; 6a, 6b, 6c are arranged one over the other such that the outwardly directed slots 5 of a lamella 3a, 3b, 3c; 6a, 6b, 6c are offset to those of the lamella 3a, 3b, 3c; 6a, 6b, 6c lying below or above so that a number of lamellae 3a, 3b, 3c; 6a, 6b, 6c form a packet the common central opening 24, of which can be widened by the shaft 7 passing through, but which in its entirety at the same time forms a flexible seal against the pressure of the medium due to the changing offset. The number of lamellae 3a, 3b, 3c, 6a, 6b, 6c of a sealing means 3, 6 is preferably arbitrary or can be chosen dependently upon the conditions of use, the lamellae 3a, 3b, 3c, 6a, 6b, 6c of one sealing means 3, 6, and particularly preferably of all sealing means 3, 6 being identical in form. Any two lamellae 3a, 3b, 3c, 6a, 6b, 6c are connected to one another by a connection section 32, 33 which forms the slot end. The sealing off of the rotating shaft 7 from a pressurised medium therefore takes place by means of the sealing lamellae 3a, 3b, 3c and 6a, 6b, 6c of which the diameter of their inner opening is smaller than the diameter of the shaft 7. By means of the slots 5 cut into each lamella 3a, 3b, 3c; 6a, 6b, 6c or by means of the slots 5 separating the lamellae 3a, 3b, 3c; 6a, 6b, 6c from one another and which are protected against undesirable pulling out in radial direction A by a rounding 4, the lamellar discs 3, 6 can spread apart for the shaft 7 with a larger diameter. Since one respective sealing lamella 3a, 3b, 3c is placed against a lamella 6a, 6b, 6c around half the angular pitch, a packet of sealing lamellae can be formed that consists of a sufficiently large number of these lamellae 3a, 3b, 3c; 6a, 6b, 6c which cover one another in the slots 5. This packet of sealing lamellae has the property that it can be placed elastically around the shaft 7 and at the same time, due to the changing cover, is tight against the medium pressure acting on the concave side of the packet of lamellae.

The action of the sealing packet is supported by the packet of lamellae being clamped between the outer ring 1 and the inner ring 2. The clamping can take place in the same way as the clamping of an elastomer sealing sleeve of the “Simmerring” design. The outer ring 1 can preferably be brought into a corresponding bearing seat for the defined holding of the seal 100.

As a result of the shaft rotation natural abrasion of the inner region of the lamellar discs 3, 6 takes place. By means of the medium pressure on the concave sides of the pressed in lamellae, all of the lamellae lying on top are constantly pressed against the shaft 7 such that they adopt the sealing function of the worn lamellae.

FIG. 2 discloses the additional region 30 which forms the round ends 4 of the slots 5. The additional wall region 30 preferably extends from the component edge forming the slot end 4 to an outer, component edge, in particular the edge a maximum distance away from the component centre or the axis of rotation. Preferably, the additional wall region 30 and the elastic wall region 3a, 3b, 3c; 9a, 9b, 9c have different elasticity modules, it also being conceivable for the elasticity modules to correspond substantially or totally.

The device 1, 2 shown three-dimensionally in FIG. 3 is described in detail by the comments made with regard to FIG. 4.

One can gather from the sectional illustration of the device 1, 2 shown in FIG. 4 that the component 1 is an outer support ring and the component 2 is an inner support ring 2. The outer support ring 1 has a collar 41 forming its outer circumference by means of which the inner ring 4 can be overlapped partially or totally. A first level base portion 42 extends from this collar 41 in the direction of the axis of rotation A or of the centre A. Adjoining this first base portion 42 is a second base portion 43, this base portion 43 being inclined with respect to a base surface 44 of the sealing means 3, 6 and increasing in thickness dependently upon the distance from the centre until it reaches an additional base portion 45 which preferably extends parallel to the base surface 44. A counter-surface 46 formed on the inner support ring 2 is preferably substantially or precisely inverse to the inner surface of the outer support ring 1 formed by the first base portion 42, the second base portion 43 and the additional base portion 45. The outer support ring 1 and the inner support ring 2 are preferably always arranged coaxially. Reference number 26 identifies the opening of the inner ring 2 through which a shaft 7 or a shaft 7 and lamellae 3a, 3b, 3c; 6a, 6b, 6c of one or several sealing means 3, 6 can extend.

FIG. 5 shows the lamellae 3a, 3b, 3c bent in direction A or in the direction of an overpressure region. One can see between the lamellae 3a, 3b, 3c the slots 5 which preferably discharge into at least partially rounded ends 4. The opening 24 can be converted into an enlarged opening width by introducing a shaft. The inner region 35 can preferably be brought two-dimensionally or linearly into contact with a shaft.

In FIG. 6 two sealing means 3, 6 arranged rotated towards one another are disposed on a shaft 7 such that displacement of the sealing means 6 is brought about in the direction 15 of an overlap of the slots 5 of the first sealing means 3 by the lamellae 6a, 6b, 6c.

FIG. 7 shows a fitted state of an embodiment according to the invention of the shaft seal 100 in a bearing seat 8 and encircling a shaft 7. The shaft seal 100 therefore brings about the delimitation of a first region 20 in which a material is to be or can be held with respect to a second region 21.

Furthermore, it can be gathered from FIG. 7 that the lamellae 6a, 6b, 6c of at least one sealing means 6 extend through an opening of the inner ring 2 in axial direction A, in particular against the material pressure.

In FIG. 8 a three-dimensional representation of an additional embodiment according to the invention is illustrated. According to this representation this embodiment has two sealing means 9, 10, in particular sealing sleeves 9, 10, and a fixing 11 for receiving the sealing sleeves 9, 10.

A detailed illustration of the sealing sleeves 9, 10 can be gathered from FIGS. 9 and 10. FIG. 9 shows e.g. that the sealing sleeves 9, 10 form an opening 25 which is suitable for introducing a shaft 7. The sealing sleeves 9, also have lamellae 9a, 9b, 9c; 10a, 10b, 10c which can press elastically against the shaft 7.

FIG. 10 shows a connection section 33 by means of which the roundings 5 are formed. Furthermore, a first, a second and an additional base region of the sealing sleeve 9, 10 are identified by reference numbers 51, 52, and 53. The first base region 51, the second base region 52 and the additional base region 53 form substantially or precisely a V-shape which corresponds to a fixing 11 for receiving the sealing sleeve(s) 9, 10 shown in FIG. 11 and at least partially inverse to the V shape of the sealing sleeve.

This embodiment is preferably suitable for larger shaft diameters.

Located in the fitting 11, which is disposed or can be disposed tightly fitted in the housing part of a unit to be sealed, is the groove 12 (FIG. 12) into which the sealing sleeves 9, 10 are inserted. By means of the outer shoulder 13 (FIG. 12) which delimits the groove 12 on the outside, the sealing sleeves 9, 10 lying over one another as a packet are secured against release. Towards the inside the sealing sleeves 9, 10 can rest freely against the rotating shaft to be sealed. The rounding 14 on the inside of the fitting 11 prevents notching of the sealing sleeves 9, 10.

The sealing sleeves 9, 10 are pressed against the surface of the shaft by the pressure of the medium 15 to be sealed. By means of the changing offset of the slots 5 of the sealing sleeves 9, 10 and by means of the pressing as a sleeve packet against the rotating shaft, the required tightness of the packet, with elasticity at the same time, is achieved.

### LIST OF REFERENCE NUMBERS

Outer ring 1
Inner ring 2
First sealing means 3; 9
Rounding, slot end 4
Slot 5
Second sealing means 6; 10
Lamellae of the first sealing means 3a, 3b, 3c
Bearing seat 8
Lamellae of the second sealing means 9a, 9b, 9c
Arrow direction 15
First region 20
Second region 21
Opening 24, 25, 26
Additional wall region 30, 31
Connection section 32, 33
Inner region 35
Collar 41
First base portion 42, 51
Second base portion 43, 52
Base surface 44
Additional base portion 45, 53
Counter-surface 46
Shaft seal 100
Axial direction A

1. An apparatus for sealing shafts, the apparatus comprising:
a first sealing means, a second sealing means and a device for pre-determined positioning of the first sealing means and of the second sealing means on a shaft, at least the first sealing means having an at least partially elastic wall region for limiting passage of fluid from a first region, in which the fluid is providable, into a second region with respect to which the shaft is sealable off from the first region, wall region of the first sealing means forming an opening through which the shaft is passable, and having a diameter that can be changed dependent upon a diameter of the shaft, the second sealing means overlapping the first sealing means at least partially with contact for sealing off the passage of fluid, wherein the first sealing means and the second sealing means are in the form of press-formed lamellar discs or of press-formed sealing sleeves which have lamellae bent in an axial direction.

2. The apparatus according to claim 1 wherein the wall region of the first sealing means is formed by lamellae extending at least in a direction of the opening and which are at least partially elastically deformable in order to be brought into contact with the shaft, slots formed between the lamellae being at least partially overlapped by the second sealing means for sealing off the passage of fluid.

3. The apparatus according to claim 2 wherein the second sealing means also has lamellae which define an opening through which the shaft is passable.

4. The apparatus according to claim 3 wherein the first sealing means and the second sealing means are arranged one over the other in the axial direction such that every slot between the lamellae of one sealing means is covered by a lamella of the other sealing means, and wherein the apparatus is configured such that as a consequence of pressure being applied resulting from the fluid a contact pressure exerted upon the first sealing means by the lamellae of the second sealing means increases.

5. The apparatus according to claim 3 wherein at least one slot in a region of a transition of two lamellae into an additional wall region of the respective sealing means is made so as to be at least partially spherical, in form by a connection section of the additional wall region that connects the two lamellae respectively.

6. The apparatus according to claim 1 further comprising at least a third sealing means.

7. The apparatus according to claim 1 wherein the device for the pre-determined positioning of the first and second sealing means has an outer ring and an inner ring, the first and second sealing means being disposed at least partially in between the rings.

8. The apparatus according to claim 7 wherein the first sealing means and the second sealing means are in the form of press-formed lamellar discs made of a respective standardized temperature-resistant material.

9. The apparatus according to claim 1 wherein the device for the pre-determined positioning of the first sealing means and of the second sealing means has an annular fitting with a groove at least partially adapted to a shape of the first sealing means and the second sealing means for receiving the first sealing means and the second sealing means, at least with form-fit, the groove on one side having, at least in some sections, means for holding at least the first sealing means or the second sealing means on the device.

10. The apparatus according to claim 9 wherein the first and second sealing means are in the form of press-formed sealing sleeves formed from a respectively standardized, temperature-resistant material.

11. The apparatus according to claim 1 wherein the second sealing means has lamellae which define an opening through which the shaft is passable.

12. The apparatus according to claim 2 wherein at least one slot in a region of a transition of two lamellae into an additional wall region of the first sealing means is made so as to be at least partially round.

13. The apparatus according to claim 4 wherein at least one slot in a region of a transition of two lamellae into an additional wall region of the respective sealing means is made so as to be at least partially round in form by a connection section of the additional wall region that connects the two lamellae.

14. The apparatus according to claim 5 further comprising at least a third sealing means.

15. The apparatus according to claim 5 wherein the device for the pre-determined positioning of the first and second sealing means has an outer ring and an inner ring, the first and second sealing means being disposed at least partially in between the rings.

16. The apparatus according to claim 15 wherein the first sealing means and the second sealing means are in the form of press-formed lamellar discs made of a temperature-resistant material.

17. The apparatus according to claim 5 wherein the device for the pre-determined positioning of the first sealing means and of the second sealing means has an annular fitting with a groove at least partially adapted to a shape of the first sealing means and the second sealing means for receiving the first sealing means and the second sealing means, the groove on one side having, at least in some sections, means for holding at least the first sealing means or the second sealing means on the device.

18. The apparatus according to claim 17 wherein the first and second sealing means are in the form of press-formed sealing sleeves formed from a temperature-resistant material.
